(19) United States
(12) Patent Application Publication
(10) Pub. No.: US 2018/0077089 A1
(43) Pub. Date: Mar. 15, 2018

(54) MULTIFACETED MESSAGE PLATFORM

(71) Applicant: sndmsg, inc., Halifax (CA)

(72) Inventors: Gavin Uhma, Halifax (CA); Benjamin Brian DeCoste, Halifax (CA); Brian Alexander McKay Jeffcock, Halifax (CA)

(21) Appl. No.: 15/705,067

(22) Filed: Sep. 14, 2017

Related U.S. Application Data
(60) Provisional application No. 62/394,654, filed on Sep. 14, 2016.
(60) Provisional application No. 62/419,789, filed on Nov. 9, 2016.

(51) Int. Cl. H04L 12/58

(52) U.S. Cl. CPC H04L 51/04; H04L 51/16; H04L 51/28

(57) ABSTRACT

Techniques for providing multifaceted message communication. A system utilizing such techniques can include a multifaceted message platform alias management system, a multifaceted message instance interaction control system, and a multifaceted message transaction record management system. A method utilizing such techniques can include management of aliases used in controlling multifaceted message communication, control of multifaceted message interaction, and management of a transaction record for a multifaceted message.

### CROSS-REFERENCE TO RELATED APPLICATIONS

This application claims priority to U.S. Provisional Patent Application No. 62/394,654, filed Sep. 14, 2016, entitled “Messaging Platform” and U.S. Provisional Patent Application No. 62/419,789, filed Nov. 9, 2016, entitled “Multifaceted Message Platform”, both of which are incorporated by reference herein.

### BRIEF DESCRIPTION OF THE DRAWINGS

FIG. 1 depicts a diagram of an example of a system for messaging using multifaceted messages.

FIG. 2 depicts a state diagram of a multifaceted message.

FIG. 3 depicts another state diagram of a multifaceted message.

FIG. 4 depicts a diagram of an example of a multifaceted message platform alias management system.

FIG. 5 depicts a diagram of an example of a multifaceted message instance interaction control system.

FIG. 6 depicts a diagram of a multifaceted message transaction record management system.

FIG. 7 depicts a flowchart of an example a method for managing multifaceted message communication.

FIG. 8 depicts a flowchart of an example of a method for maintaining a subsequent multifaceted message instance.

FIG. 9 depicts a flowchart of an example of a method for maintaining a transaction record for a multifaceted message.

### DETAILED DESCRIPTION

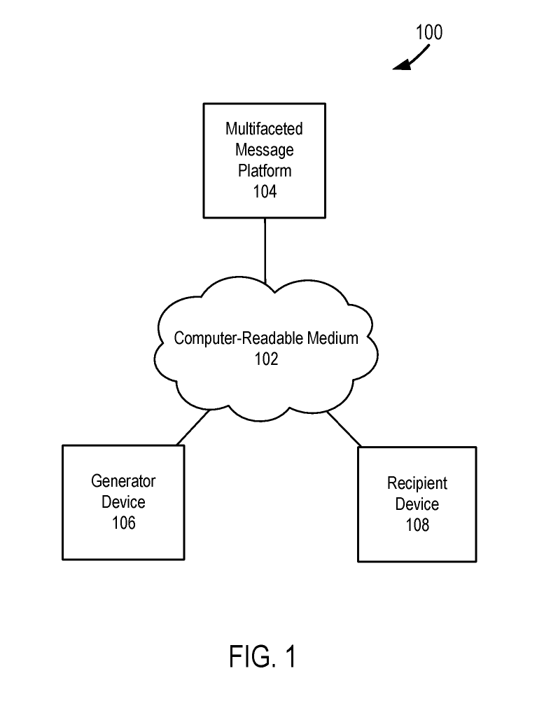

FIG. 1 depicts a diagram 100 of an example of a system for messaging using multifaceted messages. The diagram 100 includes a computer-readable medium 102, a multifaceted message platform 104, an generator device 106, and a recipient device 108. In the example system shown in FIG. 1, the multifaceted message platform 104, the generator device 106, and the recipient device 108 are coupled to each other through the computer-readable medium 102.

A computer-readable medium, as discussed in this paper, is intended to represent a variety of potentially applicable technologies. For example, a computer-readable medium can be used to form a network or part of a network. Where two components are co-located on a device, a computer-readable medium can include a bus or other data conduit or plane. Where a first component is co-located on one device and a second component is located on a different device, a computer-readable medium can include a wireless or wired back-end network, LAN, or WLAN. A computer-readable medium can also encompass a relevant portion of a WAN or other network, if applicable.

Assuming a computer-readable medium includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (hereinafter referred to as “HTTP”) for hypertext markup language (hereinafter referred to as “HTML”) documents that make up the World Wide Web (hereinafter referred to as “the web”). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

A computer-readable medium and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

A computer-readable medium and other applicable systems, platforms, or devices described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors, at least partially implemented in hardware, or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include software embodied in a computer-readable medium, firmware, or hardware for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The multifaceted message platform 104 functions to manage communication using multifaceted messages. In managing communication using multifaceted messages, the multifaceted message platform 104, can maintain multifaceted messages. In maintaining multifaceted messages, the multifaceted message platform 104 can provide or otherwise allow users to access a multifaceted message. For example, the multifaceted message platform 104 can provide an interface to a recipient on their device, e.g. using a native application or a web-based application, through which the recipient can access a multifaceted message. In another example, the multifaceted message platform 104 can provide a link to a multifaceted message, which a user can utilize to access the multifaceted message.

A message is multifaceted in that different users can interact with a multifaceted message instance representing the multifaceted message differently according to access permissions associated with the multifaceted message. For example, a first user can see first content in interacting with a multifaceted message instance while a second user can see different content in interacting with the same multifaceted message instance. Access permissions specify how a user can interact with a multifaceted message instance. Examples of access permissions include: whether a user can receive or otherwise access a message instance; what content or attached data of a multifaceted message represented by a message instance a user can view or access; whether and manners in which a user can edit content or attached data of a multifaceted message represented by a multifaceted message instance through creation of a subsequent multifaceted message instance; whether and manners in which a user can edit a multifaceted message instance through creation of a subsequent multifaceted message instance; whether a user can provide interaction access to a multifaceted message instance to other recipients through creation of a subsequent multifaceted message instance; to which recipients a user can provide interaction access to a multifaceted message instance; whether a user can modify access permissions for a multifaceted message instance through creation of a subsequent multifaceted message instance; and how a user can modify access permission for a multifaceted message instance through creation of a subsequent multifaceted message instance. Access permissions can be specific to users or aliases associated with users, for use in managing interaction based on aliases.

Interacting with a message instance, as used in this paper, includes applicable manners in which a user can exploit a multifaceted message instance. Examples of interactions with a multifaceted message instance include: creating a multifaceted message instance, causing a subsequent multifaceted message instance to be created, accessing content of a multifaceted message represented by a multifaceted message instance; editing content of a multifaceted message represented by a multifaceted message instance through creation of a subsequent instance; accessing attached data in a multifaceted message represented by a multifaceted message instance; editing attached data in a multifaceted message represented by a multifaceted message instance through creation of a subsequent multifaceted message instance; viewing recipients' granted access rights to a multifaceted message instance; viewing a generator of a multifaceted message instance, creating a multifaceted message instance; editing a multifaceted message instance through creation of a subsequent multifaceted message instance; defining which users can interact with a multifaceted message instance; editing which users can interact with a multifaceted message instance through creation of a subsequent multifaceted message instance; defining access permissions in a multifaceted message instance; and editing access permissions of a multifaceted message instance through creation of a subsequent multifaceted message instance. All users may interact with a multifaceted message instance the same way, even though a message represented by the multifaceted message instance has the capability of being multifaceted. For example, access permissions can specify that all users, including generators and recipients, are capable of viewing the same content within a message.

In a specific implementation, the multifaceted message platform 104 provides functionalities for a user to generate a multifaceted message instance. A multifaceted message instance can include content as part of a multifaceted message, identifications of recipients, e.g. aliases, data attached as part of a multifaceted message, and access permissions for a multifaceted message instance. A user can interact with a multifaceted message instance in order to provide a user access to a multifaceted message represented by the multifaceted message instance. For example, a user can access content and data included as part of a multifaceted message according to access permissions included in a corresponding multifaceted message instance by interacting with the multifaceted message instance. A user who creates a multifaceted message instance, as used in this paper, is referred to as a generator. In creating a multifaceted message instance, a generator can also function as a recipient in being able to interact with the multifaceted message instance.

In a specific implementation, the multifaceted message platform 104 can generate a multifaceted message instance based on message input received from a generator. Message input can include one or an applicable combination of content to include in a multifaceted message, a format of a multifaceted message, data attachments to include in a multifaceted message, access permission of users, e.g. originators and recipients, in interacting with a multifaceted message, recipients, e.g. aliases associated with recipients, of a multifaceted message, and desired changes to make to a multifaceted message instance. For example, message input can specify content to include in a body of a multifaceted message, recipients of the multifaceted message, and access permissions of the recipients and the multifaceted message platform 104 can generate a multifaceted message instance including the content in a body of a multifaceted message, identifications of recipients, e.g. aliases, to allow access to the multifaceted message, and identifications of access permission associated with the recipients.

In a specific implementation, the multifaceted message platform 104 provides functionalities to a generator for creating a root multifaceted message instance. A root multifaceted message instance represents an original version of a multifaceted message and can be utilized to provide user access to the original version of the multifaceted message. The multifaceted message platform 104 can generate a root multifaceted message instance based on message input received from a generator. For example, the multifaceted message platform 104 can generate a root multifaceted message instance to include content and attached data provided by a generator and include access permissions provided by a generator through message input.

In a specific implementation, the multifaceted message platform 104 provides functionalities to a generator for creating a subsequent multifaceted message instance. A subsequent multifaceted message instance is a newly created instance of a multifaceted message instance created based on desired changes to the multifaceted message instance while the multifaceted message instance remains unchanged. Therefore, in creating a subsequent multifaceted message instance based on desired changes to make to a first multifaceted message instance, the first multifaceted message instance is effectively edited without actually being changed. For example, if a generator wants to change content in a root multifaceted message instance, then the multifaceted message platform 104 can create a subsequent multifaceted message instance including the desired changes to the content based on the root multifaceted message instance. In another example, if a generator wants to change access permissions in a subsequent multifaceted message instance, then the multifaceted message platform 104 can create another subsequent multifaceted instance including the desired changes to the access permission based on the root multifaceted message instances. The multifaceted message platform 104 can create a subsequent multifaceted message instance based on message input indicating desired changes to a multifaceted message instance. A subsequent multifaceted message instance represents a subsequent or another version of a multifaceted message which includes a previous version represented by another multifaceted message instance, e.g. by a root multifaceted message instance or another subsequent multifaceted message instance. A subsequent multifaceted message instance can be used to provide a user access to a subsequent or another version of a multifaceted message.

In a specific implementation, a recipient of a root multifaceted message instance functions as a generator by using the multifaceted message platform 104 to create a subsequent multifaceted message instance of the root multifaceted message instance. For example, if a recipient modifies a root multifaceted message instance according to access permissions using the multifaceted message platform 104, then the recipient functions as a generator in creating a subsequent multifaceted message instance for the root multifaceted message instance.

In a specific implementation, the multifaceted message platform 104 functions to generate a multifaceted message instance including a link to another multifaceted message instance. A link to another multifaceted message instance included in a multifaceted message instance can be utilized by a user accessing the multifaceted message to access the another multifaceted message instance. For example, a subsequent multifaceted message instance created from a root multifaceted message instance can include a link to the root multifaceted message instance, which can be utilized by a recipient to access the root multifaceted message instance. Which users can access a link to another multifaceted message instance included as part of a multifaceted message instance can be controlled according to access permissions associated with the multifaceted message instance. For example, access permissions for a multifaceted message instance can specify that a first user is allowed to access a link to another multifaceted message instance included in the multifaceted message instance and also specify that a second user is not allowed to access the link.

In a specific implementation, the multifaceted message platform 104 functions to manage recipient and generator interaction with a multifaceted message instance according to defined access permissions. In managing interaction with a multifaceted message instance, the multifaceted message platform 104 can present to a user a multifaceted message using the multifaceted message instance according to access permissions included as part of the message instance. For example, if a multifaceted message instance includes access permissions specifying to present first content as part of a message that is the subject of the instance to a recipient, then the multifaceted message platform 104 can present the first content to the recipient. In another example, if a multifaceted message instance includes access permissions specifying to allow a recipient to view the access permissions for the instance, then the multifaceted message platform 104 can present the access permissions to the recipient. Additionally, in managing interaction with a multifaceted message instance according to defined access permissions the multifaceted message platform 104 can allow a user to access data attached to a multifaceted message represented by a multifaceted message instance according to the defined access permissions. For example, if access permissions for a multifaceted message instance specify allowing a recipient to open a document attached to a message represented by the multifaceted instance, then the multifaceted message platform 104 can allow the recipient to open the document by subsequently presenting the document to the recipient or allowing the recipient to download the document.

In a specific implementation, in managing interaction with a multifaceted message instance, the multifaceted message platform 104 functions to manage editing of the multifaceted message instance through creation of a subsequent multifaceted message instance according to access permissions. For example if a first recipient has rights to edit a multifaceted message instance through creation of a subsequent multifaceted message instance and a second recipient does not have rights to edit the multifaceted instance according to access permissions, then the multifaceted message platform 104 can create a subsequent multifaceted message instance based on desired changes of the first user and prevent creation of a subsequent multifaceted message instance for the second user, even in the second user provides their desired changes.

In a specific implementation, the multifaceted message platform 104 functions to manage identifications for multifaceted message instances. In managing identifications for multifaceted message instances, the multifaceted message platform 104 can create and associate a unique root message identification with a root multifaceted message instance. For example, the multifaceted message platform 104 can create and associate a unique root message identification when it creates a root multifaceted message instance in response to message input received from a generator. Additionally, in managing identifications for multifaceted message instances, the multifaceted message platform 104 can create and associate a unique subsequent message identification with a subsequent multifaceted message instance. For example, the multifaceted message platform 104 can create and associate a unique subsequent message identification when it creates a new subsequent multifaceted message instance in response to message input received from a generator. The multifaceted message platform 104 can be configured to include with root multifaceted message identifications and subsequent message identifications, timestamps indicating either or both when a message instance or an identification is created. For example, the multifaceted message platform 104 can include a timestamp with a root message identification to indicate when a root multifaceted message instance was created.

In a specific implementation, the multifaceted message platform 104 is configured to include generator identifications, e.g. aliases, with root message identifications and subsequent message identifications. A generator whose corresponding identification or associated alias is included with a root message identification or a subsequent message identification can be the generator who created the corresponding root multifaceted message instance or the subsequent multifaceted instance. For example, if a generator created a root multifaceted message instance, then the multifaceted message platform 104 can create and associate a root message identification including an identification of the generator with the root multifaceted message instance. In another example, if a generator created a subsequent multifaceted message instance, then the multifaceted message platform 104 can create and associate a subsequent message identification including an identification of the generator with the subsequent multifaceted message instance.

In a specific implementation, the multifaceted message platform 104 functions to monitor occurrences of users interacting with multifaceted message instances. For example, the multifaceted message platform 104 can monitor to determine when a user actually interacts with a multifaceted message instance. In monitoring occurrences of users interacting with multifaceted message instances, the multifaceted message platform 104 can generate and associate unique transaction identifications with the detected occurrences of user interaction. For example, if a recipient interacts with a multifaceted message instance two separate times, then the multifaceted message platform 104 can generate and associate two different transaction identifications with the two separate interaction occurrences by the recipient. A transaction identification can include applicable information related to a user interacting with a multifaceted message instance. For example, a transaction identification can include an identification or alias associated with a user who interacted with a multifaceted message instance and how a user interacted with a multifaceted message instance.

In a specific implementation, the multifaceted message platform 104 functions to include a timestamp as part of a transaction identification. The multifaceted message platform 104 can include timestamps in a transaction identification indicating either or both a time at which the transaction identification is created and a time at which a multifaceted message instance interaction corresponding to the transaction identification actually occurred. For example, if a recipient accesses a multifaceted message instance at a specific time, then the multifaceted message platform 104 can include in a transaction identification corresponding to the occurrence of the recipient accessing the multifaceted message instance a timestamp indicating the specific time.

In a specific implementation, the multifaceted message platform 104 maintains a transaction record for a multifaceted message instance. A message transaction record maintained for a multifaceted message can include one or an applicable combination of root message identifications, subsequent message identifications, and transaction identifications. For example, the multifaceted message platform 104 can update a message transaction record with transaction identifications for use in determining every time a user, recipient or generator, interacted with a multifaceted message instance. A message transaction record maintained by the multifaceted message platform 104 can be specific to either a root message multifaceted message instance or a subsequent multifaceted message instance. For example, a message transaction record specific to a root message multifaceted message instance can include subsequent message identifications of subsequent multifaceted message instances created from the root message multifaceted message instance and transaction identifications of occurrences of users interacting with the root message multifaceted message instance or the subsequent multifaceted message instances.

In a specific implementation, the multifaceted message platform 104 provides functionalities to a user in accessing a transaction record for a multifaceted message instance. For example, the multifaceted message platform 104 can provide an interface to a generator through which the generator can view a transaction record for a root multifaceted message instance created by the generator. The multifaceted message platform 104 can control access to a transaction record for a multifaceted message instance according to transaction record access rights. For example, if transaction records access rights indicate only allowing a generator to view a transaction record for a multifaceted message, then the multifaceted message platform 104 can prevent other users besides the generator from viewing the transaction record for the multifaceted message.

In a specific implementation, the multifaceted message platform 104 identifies users based on aliases associated with the users and utilizes aliases to manage user interaction with multifaceted message instances. For example, a multifaceted message instance can specify an alias of a recipient, as indicated by message input, to send or to otherwise provide access to the instance, and the multifaceted message platform 104 can subsequently allow or otherwise provide the recipient with access to the multifaceted message instance based on the alias. In another example, a multifaceted message instance can exclude an alias of a user and the multifaceted message platform 104 can refrain from providing or otherwise deny the user access to the multifaceted message instance based on the alias.

A user can be identifiable or associated with a plurality of aliases. For example a user can have first and second aliases that are used to send or otherwise allow the user to access different multifaceted message instances. Additionally, an alias can be associated with a plurality of users. For example, a group of users associated with an alias can receive or otherwise access a multifaceted message instance if the alias is granted access permission and is identified as a valid recipient of the instance. In being associated with a plurality of users, a single user of the plurality of user can interact with a multifaceted message instance on behalf of all of the plurality of users. For example, a single user of a plurality of users associated with a single alias can respond to a root multifaceted message instance, e.g. by providing message input to generate a subsequent multifaceted message instance, on behalf of all users associated with the single alias.

In a specific implementation, an alias associated with a user is publicly searchable. Additionally, an alias and an identification of a user or users associated with the alias can be publicly searchable. Whether either or both an alias and an identification of a user associated with the alias are made publicly searchable can be dictated according to the user. For example, the user can indicate that they want their alias but not their identification made publicly searchable and in response, the multifaceted message platform 104 can make the alias publicly searchable and keep the identification of the user private. Access to either or both an alias and an identification of a user or users can be controlled according to alias access rules. Alias access rules specify applicable rules for controlling access to a aliases and identifications of users associated with the aliases. For example, alias access rules can specify to make an alias publicly searchable and to keep an identification of a user associated with the alias private, or otherwise not publicly searchable. In another example, alias access rules can specify to make an alias viewable to a specific user or group of users.

In a specific implementation, the multifaceted message platform 104 functions to send either or both multifaceted message instances or messages represented by multifaceted message instances through applicable external platforms. Example external platforms include email accounts maintained outside of the control of the multifaceted message platform 104, social networks, instant messaging services, and short message services. For example, the multifaceted message platform 104 can send a message represented by a multifaceted message instance to a Twitter® account of a recipient. In another example, the multifaceted message platform 104 can send an image of a message represented by a multifaceted message instance to a recipient as an iMessage®. The multifaceted message platform 104 can provide a message represented by a multifaceted message instance to a recipient through an external platform according to access permissions included as part of the message instance. For example, if access permissions of a multifaceted message instance indicate only displaying specific content as part of a message represented by the instance to a recipient, then the multifaceted message platform 104 can generate a message including only the specific content and provide it to the recipient through an external platform.

In a specific implementation, the multifaceted message platform 104 can generate an external platform identification, a form of a transaction identification, when either or both a multifaceted message instance or a message represented by a multifaceted message instance is sent to a recipient through an external platform. An external platform identification can include what external platform a message or a multifaceted message instance representing the message was sent through, times at which it was sent, an indication of what was sent through the external platform, and an identification or alias of a recipient. For example, if a message represented by a multifaceted message instance is sent to a specific recipient through a short message service, then the multifaceted message platform 104 can create an external platform identification indicating that the message was sent to the specific recipient through the short message service. An external platform identification generated by the multifaceted message platform 104 can be included as part of a transaction record, e.g. for a multifaceted message instance.

In a specific implementation, the multifaceted message platform 104 functions to furnish a multifaceted message instance interaction link to a user through which a user can interact with a multifaceted message instance. For example the multifaceted message platform 104 can provide a multifaceted message instance interaction link that a recipient can use to view a message represented by the instance and presented to the recipient by the multifaceted message platform 104. The multifaceted message platform 104 can furnish a multifaceted message instance interaction link to a user using an external platform. For example, the multifaceted message platform 104 can provide a multifaceted message interaction link to a user though a short message service. Additionally, the multifaceted message platform 104 can furnish a security protected multifaceted message instance interaction link to a user. For example, the multifaceted message platform 104 can provide to a user a multifaceted message interaction link that can be activated using a code, and subsequently or concurrently provide the code to the user with the link.

The generator device 106 functions according to an applicable device for sending and receiving data used by a generator in managing multifaceted message instances. The generator device 106 can send data used in generating a multifaceted message instance. For example, the generator device 106 can send message input used to create a root multifaceted message instance. In another example, the generator device 106 can send message input used to create a subsequent multifaceted message input. Additionally, the generator device 106 can receive data used by a generator to view or otherwise interact with a message instance. For example, the generator device 106 can be used to present a message that is the subject of a multifaceted message instance to a generator. In another example, the generator device 106 can be used to present a transaction record of a multifaceted message instance to a generator.

The recipient device 108 functions according to an applicable device for sending and receiving data used by a recipient in managing multifaceted message instances. The recipient device 108 can send data used in generating a multifaceted message instance. For example, the recipient device 108 can send message input used to create a subsequent multifaceted message instance. Additionally, the recipient device 108 can receive data used by a recipient to view or otherwise interact with a message instance. For example, the recipient device 108 can be used to present a message that is the subject of a multifaceted message instance to a recipient. In another example, the recipient device 108 can be used to present a transaction record of a multifaceted message instance to a recipient.

In an example of operation of the example system shown in FIG. 1, a generator provides message input using the generator device 106 to the multifaceted message platform 104. In the example of operation of the example system shown in FIG. 1, the multifaceted message platform 104 generates a root multifaceted message instance based on the message input received from the generator device 106. Additionally, in the example of operation of the example system shown in FIG. 1, the multifaceted message platform 104 manages interaction with the root multifaceted message instance by the recipient through the recipient device 108. In the example of operation of the example system shown in FIG. 1, the multifaceted message platform 104 maintains a transaction record for the root multifaceted message instance. Further, in the example of operation of the example system shown in FIG. 1, the multifaceted message platform 104 receives from the recipient device 108 message input indicating desired changes the recipient wants to make to the root multifaceted message instance. In the example of operation of the example system shown in FIG. 1, the multifaceted message platform 104 generates a subsequent multifaceted message instance using the root multifaceted message instance and the message input received from the recipient device 108.

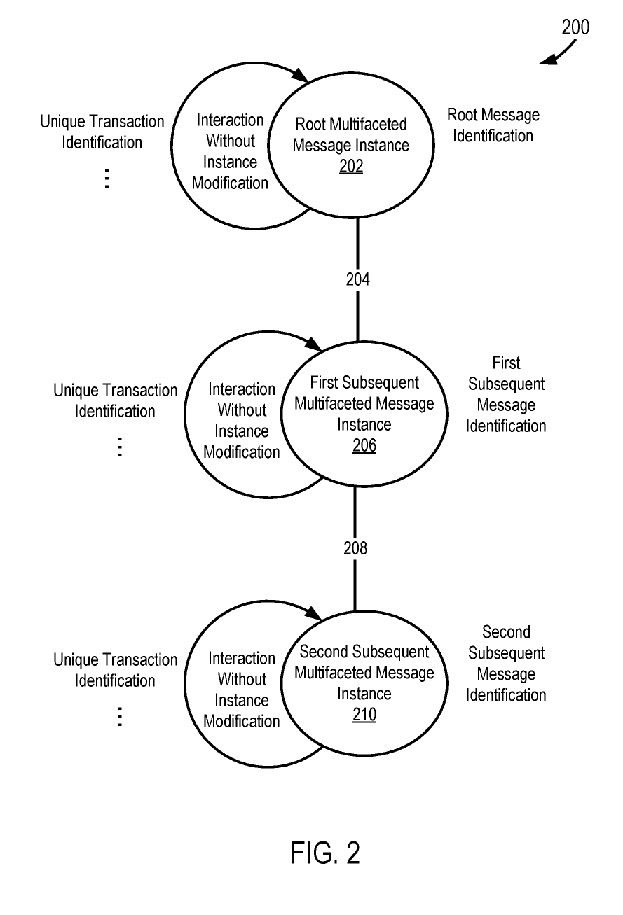

FIG. 2 depicts a state diagram 200 of a multifaceted message. The state diagram 200 includes a root multifaceted message instance 202. The root multifaceted message instance 202 can be maintained by an applicable platform for supporting multifaceted message communication, such as the multifaceted message platforms described in this paper. The root multifaceted message instance 202 can be created based on message input received from a generator.

The root multifaceted message instance 202 includes data used in presenting a multifaceted message to a recipient. For example, the root multifaceted message instance 202 can include content to display as part of a message and data attached as part of the message. Additionally, the root multifaceted message instance 202 can include access permissions used in managing user interaction with the root multifaceted message instance 202. For example, the root multifaceted message instance 202 can include access permissions specifying to display first content as part of a multifaceted message to a first recipient and display second content as part of the multifaceted message to a second recipient.

The root multifaceted message instance 202 is uniquely associated with a root message identification. An applicable platform for supporting multifaceted message communication, such as the multifaceted message platforms described in this paper, can uniquely associate the root multifaceted message instance 202 to a root message identification. A root message identification uniquely associated with the root multifaceted message instance 202 can form part of a transaction record for the multifaceted message represented by the state diagram 200.

When a user interacts with the root multifaceted message instance 202 without indicating desired changes to make to the root multifaceted message instance 202 or the user lacks rights to edit the root multifaceted message instance 202 through creation of a subsequent multifaceted message instance, a unique transaction identification is created and associated with the interaction. An applicable platform for supporting multifaceted message communication, such as the multifaceted message platforms described in this paper, can create and associate a unique transaction identification when a user interacts with the root multifaceted message instance 202. Unique transaction identifications can form part of a transaction record for the multifaceted message represented by the state diagram 200.

The state diagram 200 includes, at 204, a user indicating desired changes to make to the root multifaceted message instance 202. In indicating desired changes to make to the root multifaceted message instance 202, a user acts as a generator. In a specific implementation, desired changes to make to the root multifaceted message instance 202 are indicated by a recipient of the root multifaceted message instance 202. For example, a recipient can edit content of a multifaceted message represented by the root multifaceted message instance 202. Desired changes to make to the root multifaceted message instance 202 can be indicated by message input provided by a user or generated in response to interaction with the root multifaceted message instance 202 by a user.

In response to an indication of desired changes to the root multifaceted message instance 202 and based on a determination that the user has the right to edit the root multifaceted message instance 202 through creation of a subsequent instance, a first subsequent multifaceted message instance 206 is created based on the desired changes to make to the root multifaceted message instance 202. For example, if a user wants to change content to present as part of a multifaceted message represented by the root multifaceted message instance 202 and the user has the right to edit the instance through creation of a subsequent instance, then the first subsequent multifaceted message instance 206 can be created to reflect the changes to the content to be presented. An applicable platform for supporting multifaceted message communication, such as the multifaceted message platforms described in this paper, can create the first subsequent multifaceted message instance 206 in response to an indication of desired changes to the root multifaceted message instance 202.

The first subsequent multifaceted message instance 206 is uniquely associated with a first subsequent message identification. An applicable platform for supporting multifaceted message communication, such as the multifaceted message platforms described in this paper, can uniquely associate the first subsequent multifaceted message instance 206 to a first subsequent multifaceted message identification. A first subsequent message identification uniquely associated with the first subsequent multifaceted message instance 206 can form part of a transaction record for the multifaceted message represented by the state diagram 200.

When a user interacts with the first subsequent multifaceted message instance 206 without indicating desires changes to make to the first subsequent multifaceted message instance 206 or the user lacks rights to edit the first subsequent multifaceted message instance 206 through creation of a subsequent multifaceted message instance, a unique transaction identification is created and associated with the interaction. An applicable platform for supporting multifaceted message communication, such as the multifaceted message platforms described in this paper, can create and associate a unique transaction identification when a user interacts with the first subsequent multifaceted message instance 206. Unique transaction identifications generated and associated with interactions with the first subsequent multifaceted message instance 206 can form part of a transaction record for the multifaceted message represented by the state diagram 200.

The state diagram 200 includes, at 208, a user indicating desired changes to make to the first subsequent multifaceted message instance 206. In indicating desired changes to make to the first subsequent multifaceted message instance 206, a user acts as a generator. In a specific implementation, desired changes to the first subsequent multifaceted message instance 206 are indicated by a recipient of the first subsequent multifaceted message instance 206. For example, a recipient can indicate desired edits to content of a multifaceted message represented by the first subsequent multifaceted message instance 206. Desired changes to the first subsequent multifaceted message instance 206 can be indicated by message input provided or created based on interactions by a user with the first subsequent multifaceted message instance 206.

In response to an indication of desired changes to the first subsequent multifaceted message instance 206 and based on a determination that the user has the right to edit the first subsequent multifaceted message instance 206 through creation of a subsequent instance, a second subsequent multifaceted message instance 210 is created based on the desired changes to make to the first subsequent multifaceted message instance 206. For example, if a user wants to change content to present as part of a multifaceted message represented by the first subsequent multifaceted message instance 206 and the user has the rights to edit the instance through creation of a subsequent instance, then the second subsequent multifaceted message instance 210 can be created to reflect the desired changes to the content to be presented. An applicable platform for supporting multifaceted message communication, such as the multifaceted message platforms described in this paper, can create the second subsequent multifaceted message instance 210 in response to desired changes to be made to the first subsequent multifaceted message instance 206.

The second subsequent multifaceted message instance 210 is uniquely associated with a second subsequent message identification. An applicable platform for supporting multifaceted message communication, such as the multifaceted message platforms described in this paper, can uniquely associate the second subsequent multifaceted message instance 210 to a second subsequent multifaceted message identification. A second subsequent message identification uniquely associated with the second subsequent multifaceted message instance 210 can form part of a transaction record for the multifaceted message represented by the state diagram 200.

When a user interacts with the second subsequent multifaceted message instance 210 without indicating desires changes to make to the second subsequent multifaceted message instance 210 or the user lacks rights to edit the second subsequent multifaceted message instance 210 through creation of a subsequent multifaceted message instance, a unique transaction identification is created and associated with the interaction. An applicable platform for supporting multifaceted message communication, such as the multifaceted message platforms described in this paper, can create and associate a unique transaction identification when a user interacts with the second subsequent multifaceted message instance 210. Unique transaction identifications generated and associated with interactions with the second subsequent multifaceted message instance 210 can form part of a transaction record for the multifaceted message represented by the state diagram 200.

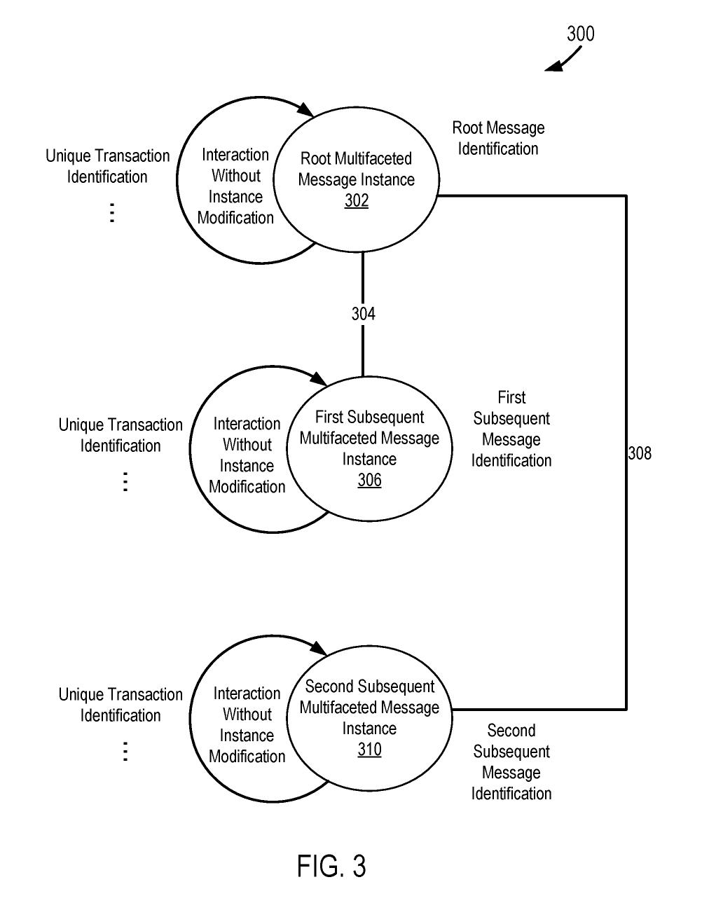

FIG. 3 depicts another state diagram 300 of a multifaceted message. The state diagram 300 includes a root multifaceted message instance 302. The root multifaceted message instance 302 can be maintained by an applicable platform for supporting multifaceted message communication, such as the multifaceted message platforms described in this paper. The root multifaceted message instance 302 can be created based on message input received from a generator.

The root multifaceted message instance 302 includes data used in presenting a multifaceted message to a recipient. For example, the root multifaceted message instance 302 can include content to display as part of a message and data attached as part of the message. Additionally, the root multifaceted message instance 302 can include access permissions used in managing user interaction with the root multifaceted message instance 302. For example, the root multifaceted message instance 302 can include access permissions specifying to display first content as part of a multifaceted message to a first recipient and display second content as part of the multifaceted message to a second recipient.

The root multifaceted message instance 302 is uniquely associated with a root message identification. An applicable platform for supporting multifaceted message communication, such as the multifaceted message platforms described in this paper, can uniquely associate the root multifaceted message instance 302 to a root message identification. A root message identification uniquely associated with the root multifaceted message instance 302 can form part of a transaction record for the multifaceted message represented by the state diagram 300.

When a user interacts with the root multifaceted message instance 302 without indicating desired changes to make to the root multifaceted message instance 302 or the user lacks rights to edit the root multifaceted message instance 302 through creation of a subsequent multifaceted message instance, a unique transaction identification is created and associated with the interaction. An applicable platform for supporting multifaceted message communication, such as the multifaceted message platforms described in this paper, can create and associate a unique transaction identification when a user interacts with the root multifaceted message instance 302. Unique transaction identifications can form part of a transaction record for the multifaceted message represented by the state diagram 300.

The state diagram 300 includes, at 304, a user indicating desires changes to make to the root multifaceted message instance 302. In indicating desired changes to make to the root multifaceted message instance 302, a user acts as a generator. In a specific implementation, desired changes to make to the root multifaceted message instance 302 are indicated by a recipient of the root multifaceted message instance 302. For example, a recipient can edit content of a multifaceted message represented by the root multifaceted message instance 302. Desired changes to make to the root multifaceted message instance 302 can be indicated by message input provided by a user or generated in response to interaction with the root multifaceted message instance 302 by a user.

In response to an indicating of desired changes to the root multifaceted message instance 302 and based on a determination that the user has the right to edit the root multifaceted message instance 302 through creation of a subsequent instance, a first subsequent multifaceted message instance 306 is created based on the desired changes to make to the root multifaceted message instance 302. For example, if a user wants to change content to present as part of a multifaceted message represented by the root multifaceted message instance 302 and the user has the right to edit the instance through creation of a subsequent instance, then the first subsequent multifaceted message instance 306 can be created to reflect the changes to the content to be presented. An applicable platform for supporting multifaceted message communication, such as the multifaceted message platforms described in this paper, can create the first subsequent multifaceted message instance 306 in response to an indication of desired changes to the root multifaceted message instance 302.

The first subsequent multifaceted message instance 306 is uniquely associated with a first subsequent message identification. An applicable platform for supporting multifaceted message communication, such as the multifaceted message platforms described in this paper, can uniquely associate the first subsequent multifaceted message instance 306 to a first subsequent multifaceted message identification. A first subsequent message identification uniquely associated with the first subsequent multifaceted message instance 306 can form part of a transaction record for the multifaceted message represented by the state diagram 300.

When a user interacts with the first subsequent multifaceted message instance 306 without indicating desired changes to make to the first subsequent multifaceted message instance 306 or the user lacks rights to edit the first subsequent multifaceted message instance 306 through creation of a subsequent multifaceted message instance, a unique transaction identification is created and associated with the interaction. An applicable platform for supporting multifaceted message communication, such as the multifaceted message platforms described in this paper, can create and associate a unique transaction identification when a user interacts with the first subsequent multifaceted message instance 306. Unique transaction identifications generated and associated with interactions with the first subsequent multifaceted message instance 306 can form part of a transaction record for the multifaceted message represented by the state diagram 300.

The state diagram 300 includes, at 308, a user indicating desired additional changes to make to the root multifaceted message instance 302. The desired additional changes to make to the root multifaceted message instance 302 at 308 can be the same as or different from the desired changes indicated at 304. In indicating desired changes to make to the root multifaceted message instance 302, a user acts as a generator. A user who indicates desired changes at 308 can be a different user than the user who indicated the desired changes at 304. In a specific implementation, desired changes to the root multifaceted message instance 302 are indicated by a recipient of the root multifaceted message instance 302. For example, a recipient can indicate desired edits to content of a multifaceted message represented by the root multifaceted message instance 302. Desired changes to the root multifaceted message instance 302 can be indicated by message input provided or created based on interactions by a user with the root multifaceted message instance 302.

In response to an indication of desired changes to the root multifaceted message instance 302, at 308, and based on a determination that the user has the right to edit the root multifaceted message instance, a second subsequent multifaceted message instance 310 is created based on the desired changes to make to the root multifaceted message instance 302. For example, if a user wants to change content to present as part of a multifaceted message represented by the root multifaceted message instance 302 and the user has the rights to edit the instance through creation of a subsequent instance, then the second subsequent multifaceted message instance 310 can be created to reflect the desired changes to the content to be presented. An applicable platform for supporting multifaceted message communication, such as the multifaceted message platforms described in this paper, can create the second subsequent multifaceted message instance 310 in response to changes made at 308 to the root multifaceted message instance 302.

The second subsequent multifaceted message instance 310 is uniquely associated with a second subsequent message identification. An applicable platform for supporting multifaceted message communication, such as the multifaceted message platforms described in this paper, can uniquely associate the second subsequent multifaceted message instance 310 to a second subsequent multifaceted message identification. A second subsequent message identification uniquely associated with the second subsequent multifaceted message instance 310 can form part of a transaction record for the multifaceted message represented by the state diagram 300.

When a user interacts with the second subsequent multifaceted message instance 310 without indicating desired changes to make to the second subsequent multifaceted message instance 310 or the user lacks rights to edit the second subsequent multifaceted message instance 310 through creation of a subsequent multifaceted message instance, a unique transaction identification is created and associated with the interaction. An applicable platform for supporting multifaceted message communication, such as the multifaceted message platforms described in this paper, can create and associate a unique transaction identification when a user interacts with the second subsequent multifaceted message instance 310. Unique transaction identifications generated and associated with interactions with the second subsequent multifaceted message instance 310 can form part of a transaction record for the multifaceted message represented by the state diagram 300.

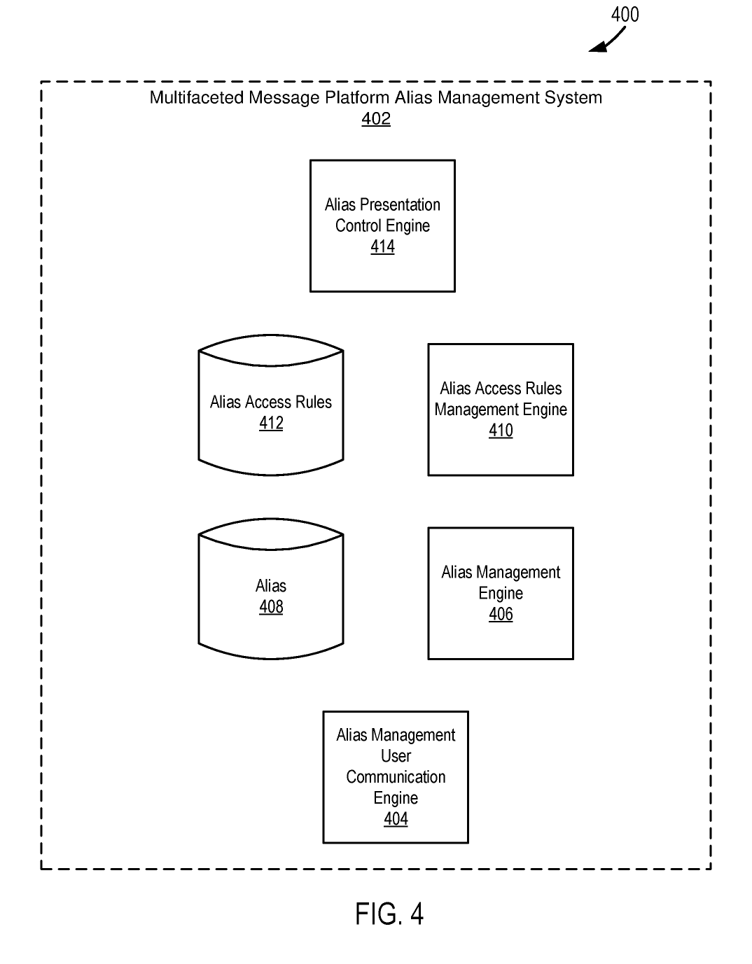

FIG. 4 depicts a diagram 400 of an example of a multifaceted message platform alias management system 402. The multifaceted message platform alias management system 402 functions to manage aliases for use in multifaceted message communication. The multifaceted message platform alias management system 402 can be included as part of an applicable platform for supporting multifaceted message communication, such as the multifaceted message platforms described in this paper. In managing aliases for use in multifaceted message communication, the multifaceted message platform alias management system 402 can assign and uniquely associate an alias with a user. Additionally, in managing aliases for use in multifaceted message communication, the multifaceted message platform alias management system 402 can maintain alias access rules for controlling presentation aliases to users capable of communicating using multifaceted messages. Further, in managing aliases for use in multifaceted message communication, the multifaceted message platform alias management system 402 can present either or both aliases or identifications of users according to alias access rules.

The multifaceted message platform alias management system 402 shown in FIG. 4 includes an alias management user communication engine 404, an alias management engine 406, an alias datastore 408, an alias access rules management engine 410, an alias access rules datastore 412, and an alias presentation control engine 414. The alias management user communication engine 404 functions to communicate with a user or a plurality of users regarding aliases used in multifaceted message communication. The alias management user communication engine 404 can receive alias input from a user or a plurality of users. Alias input can include applicable data related to establishing and maintaining an alias for a user for purposes of multifaceted message communication. Examples of alias input include one or an applicable combination of a desired alias, an indicating of whether an alias is accepted, identifications of a user or users to uniquely associate with an alias, and alias access rules associated with an alias.

In a specific implementation, the alias management user communication engine 404 functions to communicate with a user or a plurality of users for purposes of selecting an alias to associate with the user or the plurality of users. In communicating with a user or a plurality of users for purposes of selecting an alias to associate with the user or the plurality of users, the alias management user communication engine 404 can present a list of available aliases to the user or the plurality of users. Additionally, in communicating with a user or a plurality of users for purposes of selecting an alias to associate with the user or the plurality of users, the alias management user communication engine 404 can inform the user of the plurality of users that a desired alias is unavailable. Further, in communicating with a user or the plurality of users for purposes of selecting an alias to associate with the user or the plurality of users, the alias management user communication engine 404 can receive alias input indicating an alias selected by the user or the plurality of users in response to being presented with a list of available aliases.

The alias management engine 406 functions to manage aliases of users for use in providing multifaceted message communication. In managing aliases of users, the alias management engine 406 can assign and associate an alias with a user or a plurality of users. For example, the alias management engine 406 can associate an alias for a department with users in the department. In another example the alias management engine 406 can associate a specific alias with a user for purposes of providing multifaceted message communication capabilities to the user. The alias management engine 406 can assign and associate an alias with a user or a plurality of users based on received alias input. For example, alias input can specify to associate a specific user with a specific alias, and the alias management engine 406 can associate the specific user with the specific alias. The alias management engine 406 can associate a user identification of a user or a plurality of users with an alias the alias management engine 406 is associating with an alias.

In a specific implementation, the alias management engine 406 functions to determine one or a plurality of available aliases for a user or a plurality of users. For example, the alias management engine 406 can determine one or a plurality of aliases to suggest to a user which the user can then provide input indicating a selection of the aliases to utilize. The alias management engine 406 can determine one or a plurality of available aliases for a user or a plurality of users based on alias input received from the user or the plurality of users. For example, if alias input indicates a specific alias desired by a user and the alias management engine 406 determines the specific alias is already being used, then the alias management engine 406 can select additional aliases for the user based on the desired specific alias.

In a specific implementation, the alias management engine 406 functions to maintain alias data. In maintaining alias data, the alias management engine 406 can generate and update alias data to indicate aliases associated with users. Additionally, in maintaining alias data, the alias management engine 406 can generate and update alias data to include identifications of users associated with specific aliases.

The alias datastore 408 functions to store alias data used in providing multifaceted message communication. Alias data stored in the alias datastore 408 can be maintained by an applicable engine for managing aliases for use in providing multifaceted message communication, such as the alias management engines described in this paper. Alias data stored in the alias datastore 408 can indicate aliases a user is associated with and identifications of users associated with specific aliases.

In a specific implementation, the alias datastore 408 functions to store alias data indicating a plurality of aliases associated with a user. For example, the alias datastore 408 can store alias data indicating a first alias associated with a user, which can be used to allow the user to interact with a first multifaceted message instance, and a second alias associated with the user, which can be used to allow the user to interact with a second different multifaceted message instance. Further, in a specific implementation, the alias datastore 408 functions to store alias data indicating a plurality of users associated with an alias. In being associated with a plurality of users, a single user of the plurality of users can interact with a multifaceted message instance using the alias, on behalf of the entire plurality of users.

The alias access rules management engine 410 functions to maintain alias access rules used in providing multifaceted message communication. In maintaining alias access rules, the alias access rules management engine 410 can generate and update alias access rules data. The alias access rules management engine 410 can maintain alias access rules based on alias input received from a user. For example, if alias input specifies that an alias should be made publicly viewable, then the alias access rules management engine 410 can update alias access rules to indicate allowing the alias to be publicly viewable. In another example, if alias input specifies that an identification of a user associated with an alias should be made publicly viewable, then the alias access rules management engine 410 can update alias access rules to indicate allowing the identification of the user to be publicly viewable.

The alias presentation control engine 414 functions to manage presentation of aliases to users utilizing an applicable platform for supporting multifaceted message communication, such as the multifaceted message platforms described in this paper. In managing presentation of aliases to users, the alias presentation control engine 414 can determine whether to present an alias to a user or a plurality of users and subsequently present the alias to the user or the plurality of users if it determined to present the alias to the user or the plurality of users. Alias presented to a user by the alias presentation control engine 414 can be utilized by users to generate message input for generating multifaceted message instances. For example, a generator can be presented an alias associated with a specific group of users by the alias presentation control engine 414 and subsequently generate message input including the alias indicating that the group of users are recipients of a multifaceted message generated from the input.

In a specific implementation, the alias presentation control engine 414 functions to manage presentation of identifications of users associated with aliases to users utilizing an applicable platform for supporting multifaceted message communication, such as the multifaceted message platforms described in this paper. In managing presentation of identifications of users associated with aliases, the alias presentation control engine 414 can determine whether to present an identification of a user associated with an alia to a user or a plurality of users and subsequently present the identification to the user or the plurality of users if it determined to present the identification to the user or the plurality of users. Identifications of users associated with alias that the alias presentation control engine 414 can control presentation of can be utilized by users to generate message input for generating multifaceted message instances. For example, a generator can be presented identifications of users associated with a specific alias by the alias presentation control engine 414 and subsequently generate message input including the alias indicating that the group of users are recipients of a multifaceted message generated from the input.

In a specific implementation, the alias presentation control engine 414 functions to manage presentation of either or both aliases and identifications of users associated with aliases based on alias access rules. For example, if alias access rules indicate to make a specific alias viewable to a certain group of users, e.g. as indicated by aliases, then the alias presentation control engine 414 can make the specific alias viewable to the certain group of users. In another example, if alias access rules indicate to make an identification of a user associated with a specific alias publicly viewable, then the alias presentation control engine 414 can make the identification of the user associated with the specific alias publicly viewable to users of an applicable system for facilitating communication using multifaceted messages, such as the multifaceted message platforms described in this paper.

In an example of operation of the example system shown in FIG. 4, the alias management user communication engine 404 receives alias input from a user of an applicable system for facilitating communication using multifaceted messages, such as the multifaceted message platforms described in this paper. In the example of operation of the example system shown in FIG. 4, the alias management engine 406 maintains alias data stored in the alias datastore 408 indicating an established alias based on the received alias input. Further, in the example of operation of the example system shown in FIG. 4, the alias access rules management engine 410 maintains alias access rules data stored in the alias access rules datastore 412 for use in presenting the established alias to users of an applicable system for facilitating communication using multifaceted messages, such as the multifaceted message platforms described in this paper. In the example of operation of the example system shown in FIG. 4, the alias presentation control engine 414 presents the established alias to users based on the alias access rules data for use in generating message input for facilitating multifaceted message communication.

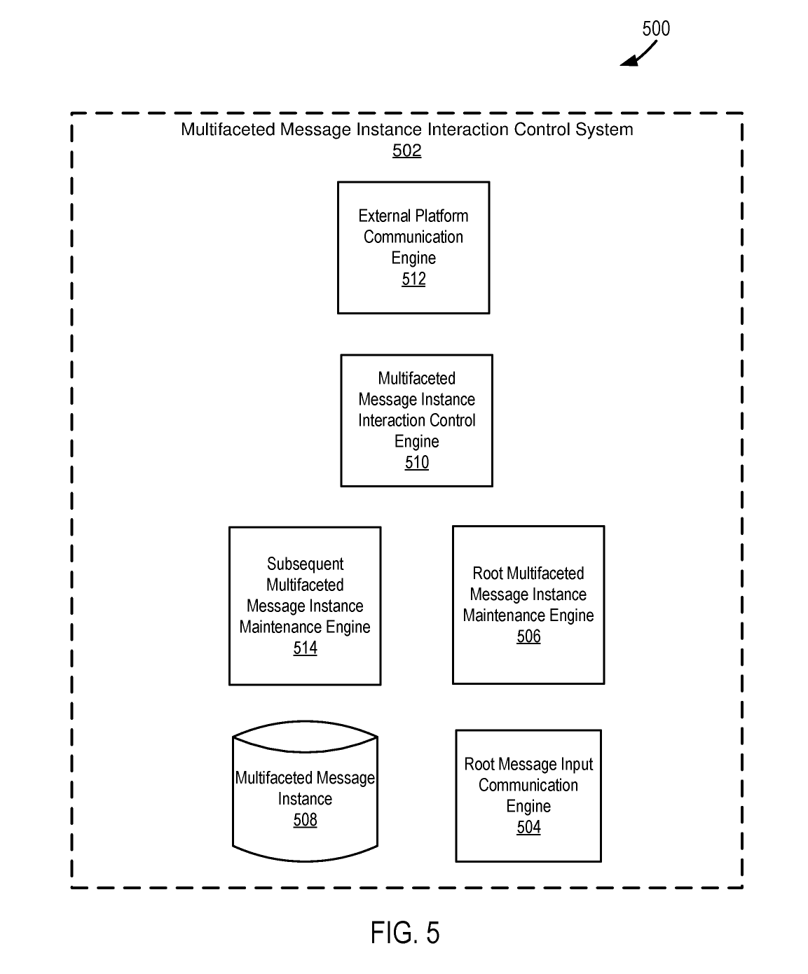

FIG. 5 depicts a diagram 500 of an example of a multifaceted message instance interaction control system 502. The multifaceted message instance interaction control system 502 functions to manage user interaction with multifaceted message instances used in facilitating multifaceted message communication. The multifaceted message instance interaction control system 502 can be included as part of an applicable platform for supporting multifaceted message communication, such as the multifaceted message platforms described in this paper. In managing user interaction with a multifaceted message instance, the multifaceted message instance interaction control system 502 can control what content and data included as part of a multifaceted message represented by the multifaceted message instance a user can be presented with or access. For example, the multifaceted message instance interaction control system 502 can control what content is reproduced for a user as part of a multifaceted message and what attached data of a multifaceted message a user can access. Further, in managing user interaction with a multifaceted message instance, the multifaceted message instance interaction control system 502 can control a user editing or changing a multifaceted message instance through creation of a subsequent multifaceted message instance.

In a specific implementation, the multifaceted message instance interaction control system 502 manages interaction with a multifaceted message instance according to access permissions included as part of the multifaceted message instance. In managing user interaction with a multifaceted message instance according to access permissions, the multifaceted message instance interaction control system 502 can control what content and data included as part of a multifaceted message represented by the multifaceted message instance a user can be presented with or access according to the access permissions. Further, in managing user interaction with a multifaceted message instance according to access permissions, the multifaceted message instance interaction control system 502 can control a user editing or changing a multifaceted message instance to create a subsequent multifaceted message instance of a multifaceted message based on the access permissions.

The multifaceted message instance interaction control system 502 shown in FIG. 5 includes a root message input communication engine 504, a root multifaceted message instance maintenance engine 506, a multifaceted message instance datastore 508, a multifaceted message instance interaction control engine 510, an external platform communication engine 512, and a subsequent multifaceted message instance maintenance engine 514. The root message input communication engine 504 functions to receive message input for generating a root multifaceted message instance of a multifaceted message. Specifically, the root message input communication engine 504 can receive message input from a generator used in creating a root multifaceted message instance for a multifaceted message. For example, the root message input communication engine 504 can receive message input indicating content or data to include as part of an original multifaceted message, recipients to allow interaction with a root multifaceted message instance of an original multifaceted message, and access permissions to control user interaction with a root multifaceted message instance of an original multifaceted message.

In a specific implementation, the root message input communication engine 504 functions to receive message input based on messages created using an external platform. In receiving message input based on messages created using an external platform, the root message input communication engine 504 can receive message input indicating messages sent by a user through a standard email platform, e.g. a platform that lacks functionalities for facilitating multifaceted message communication. For example, the root message input communication engine 504 can receive message input indicating a non-multifaceted message sent through a standard email platform.

The root multifaceted message instance maintenance engine 506 functions to maintain root multifaceted message instances for multifaceted messages, as included as part of multifaceted message instance data. In maintaining root multifaceted message instances for multifaceted messages, the root multifaceted message instance maintenance engine 506 can generate root multifaceted message instances. The root multifaceted message instance maintenance engine 506 can generate root multifaceted message instances based on received message input. For example, if the root multifaceted message instance maintenance engine 506 receives message input indicating first and second content of a message to display according to specific access parameters as part of a multifaceted message, then the root multifaceted message instance maintenance engine 506 can generate a root multifaceted message instance which includes the first and second content and the access parameters. A root multifaceted message instance generated by the root multifaceted message instance maintenance engine 506 can be used to provide a user with access to an original version of a multifaceted message.

The multifaceted message instance datastore 508 functions to store multifaceted message instance data. Multifaceted instance data stored in the multifaceted message instance datastore 508 can indicate generated multifaceted message instances for a multifaceted message. For example multifaceted instance data stored in the multifaceted message instance datastore 508 can indicate one or an applicable combination of a root multifaceted message instance and subsequent multifaceted message instances for a multifaceted message.

The multifaceted message instance interaction control engine 510 functions to control interaction with a multifaceted message instance based on aliases of users. In controlling interaction with a multifaceted message instance, the multifaceted message instance interaction control engine 510 can control interaction with either or both a root multifaceted message instance or a subsequent multifaceted message instance based on aliases associated with users. Additionally, in controlling interaction with a multifaceted message instance, the multifaceted message instance interaction control engine 510 can control access to either or both a multifaceted message instance or a multifaceted message represented by a multifaceted message instance based on aliases associated with users. For example, the multifaceted message instance interaction control engine 510 can control what content in a multifaceted message is presented to a user, based on an alias associated with the user, as part of the user interacting with a multifaceted message instance representing the multifaceted message. In another example, the multifaceted message instance interaction control engine 510 can control what portions of a multifaceted message instance a user can edit to create a subsequent multifaceted message instance, based on an alias associated with the user.

In a specific implementation, the multifaceted message instance interaction control engine 510 functions to control interaction with a multifaceted message instance according to access permissions. In controlling interaction with a multifaceted message instance according to access permissions, the multifaceted message instance interaction control engine 510 can control interaction with either or both a root multifaceted message instance or a subsequent multifaceted message instance. Additionally, in controlling interaction with a multifaceted message instance according to access permissions, the multifaceted message instance interaction control engine 510 can control access to either or both a multifaceted message instance or a multifaceted message represented by a multifaceted message instance. For example, the multifaceted message instance interaction control engine 510 can control, according to access permissions, what content in a multifaceted message is presented to a user as part of the user interacting with a multifaceted message instance representing the multifaceted message. In another example, the multifaceted message instance interaction control engine 510 can control, according to access permissions, what portions of a multifaceted message instance a user can edit to create a subsequent multifaceted message instance.

In a specific implementation, the multifaceted message instance interaction control engine 510 functions to generate or receive message input used in generating a subsequent multifaceted message instance. The multifaceted message instance interaction control engine 510 can generate or receive message input based on user interaction with a multifaceted message instance as controlled by the multifaceted message instance interaction control engine 510. For example, if a user, in interacting with a multifaceted message instance, indicates desired changes to content of a multifaceted message represented by the multifaceted message instance, then the multifaceted message instance interaction control engine 510 can generate message input indicating the desired changes to the content. In another example, if a user indicates desired changes to access permissions of a multifaceted message instance in interacting with the instance, as controlled by the multifaceted message instance interaction control engine 510, then the multifaceted message instance interaction control engine 510 can generate message input to indicate the desired changes to the access permissions.

In a specific implementation, the multifaceted message instance interaction control engine 510 can instruct an applicable engine for communicating through an external platform, such as the external communication platform engines described in this paper, to communicate with a user regarding a multifaceted message instance. In instructing an external platform communication engine to communicate with a user regarding a multifaceted message instance, the multifaceted message instance interaction control engine 510 can instruct a multifaceted message instance interaction link be sent to a user. For example, the multifaceted message instance interaction control engine 510 can instruct an external platform communication engine to send a multifaceted message instance interaction link to a user through an external platform if the user is identified as a recipient for accessing the instance, based on an alias of the user. Further in the example, the multifaceted message instance interaction control engine 510 can control user interaction with the multifaceted message instance accessed through link. Additionally, in instructing an external platform communication engine to communicate with a user regarding a multifaceted message instance, the multifaceted message instance interaction control engine 510 can instruct the external platform communication engine to notify a user through an external platform they have gained an ability to interact with, either as a recipient or a generator, the multifaceted message instance.

In a specific implementation, the multifaceted message instance interaction control engine 510 functions to directly communicate with a user through an applicable multifaceted message platform, such as the multifaceted message platforms described in this paper. In directly communicating with a user through a multifaceted message platform, the multifaceted message instance interaction control engine 510 can notify a user through the multifaceted message platform they have gained an ability to interact with a multifaceted message instance. For example, if a multifaceted message instance specifies a user is a recipient of a version of a multifaceted message represented by the multifaceted message instance, then the multifaceted message instance interaction control engine 510 can notify the user, directly through a multifaceted message platform, they have gained the ability to interact with the multifaceted message instance.

The external platform communication engine 512 functions to communicate with a user through an external platform regarding multifaceted message communications. In communicating with a user through an external platform, the external platform communication engine 512 can use an external communication platform to provide a user with either or both a notification of an available multifaceted message instance and a multifaceted message instance interaction link. For example, the external platform communication engine 512 can provide to a user through an external platform a notification indicating the user has gained the ability to interact with a specific multifaceted message instance. The external platform communication engine 512 can communicate with a user through an external platform according to instructions received by an applicable engine for managing user interaction with a multifaceted message instance, such as the multifaceted message instances described in this paper. For example, the external platform communication engine 512 can provide a multifaceted message instance interaction link to a user through an external platform in response to received instructions indicating to provide the link to the user.

The subsequent multifaceted message instance maintenance engine 514 functions to maintain subsequent multifaceted message instances for multifaceted messages, as included as part of multifaceted message instance data. In maintaining subsequent multifaceted message instances for multifaceted messages, the subsequent multifaceted message instance maintenance engine 514 can generate subsequent multifaceted message instances. The subsequent multifaceted message instance maintenance engine 514 can generate subsequent multifaceted message instances based on user interaction with multifaceted message instances. For example, if a user, in interacting with a root multifaceted message instance representing an original version of a multifaceted message, indicates desired changes to make to the multifaceted message, then the subsequent multifaceted message instance maintenance engine 514 can create a subsequent multifaceted message instance representing a subsequent version of the multifaceted message including the desired changes made to multifaceted message.

In a specific implementation, the subsequent multifaceted message instance maintenance engine 514 functions to maintain subsequent multifaceted message instances based on message input. For example if message input indicates specific changes a user to make to a multifaceted message instance, then the subsequent multifaceted message instance maintenance engine 514 can generate a subsequent multifaceted message instance to include the specific changes to the multifaceted message instance. The subsequent multifaceted message instance maintenance engine 514 can maintain a subsequent multifaceted message instance based on message input generated by an applicable system for managing user interaction with a multifaceted message instances, such as the multifaceted message instance interaction control engines described in this paper.

In a specific implementation, the subsequent multifaceted message instance maintenance engine 514 functions to maintain subsequent multifaceted message instances according to access permissions. For example, the subsequent multifaceted message instance maintenance engine 514 can determine from access permissions whether a user has a right to edit a multifaceted message instance by creating a subsequent multifaceted message instance. Further in the example, if the subsequent multifaceted message instance maintenance engine 514 determines the user has the right to edit the multifaceted message instance, then the subsequent multifaceted message instance maintenance engine 514 can generate the subsequent multifaceted message instance according to the user's desired changes to the multifaceted message instance. Additionally, the subsequent multifaceted message instance maintenance engine 514 can determine what desired changes to include in subsequent multifaceted message instances according to access permissions. For example, if access permissions specify a user is allowed to change first content but not second content, and message input indicates the user wants to change both the first content and the second content in a multifaceted message instance, then the subsequent multifaceted message instance maintenance engine 514 can generate a subsequent multifaceted instance which only includes the changes to the first content.

In an example of operation of the example system shown in FIG. 5, the root message input communication engine 504 receives first message input regarding a multifaceted message. In the example of operation of the example system shown in FIG. 5, the root multifaceted message instance maintenance engine 506 generates a root multifaceted message instance, as indicated by multifaceted message instance data stored in the multifaceted message instance datastore 508, based on the first message input. Further, in the example of operation of the example system shown in FIG. 5, the multifaceted message instance interaction control engine 510 controls a recipient's interaction with the root multifaceted message instance.

In the example of operation of the example system shown in FIG. 5, the multifaceted message instance interaction control engine 510 generates second message input indicating the recipient's desired changes to the root multifaceted message instance based on the interactions of the recipient with the instance. Additionally, in the example of operation of the example system shown in FIG. 5, the subsequent multifaceted message instance maintenance engine 514 determines, from access permissions of the root multifaceted message instance, whether the recipient has a right to edit the root multifaceted message instance through the creation of a subsequent multifaceted message instance. In the example of operation of the example system shown in FIG. 5, if it is determined the user has the right to edit the root multifaceted message instance, then the subsequent multifaceted message instance maintenance engine 514 generates the subsequent multifaceted message instance to include at least a portion of the desired changes and updates the multifaceted message instance data stored in the multifaceted message instance datastore 508 to include the subsequent multifaceted message instance.

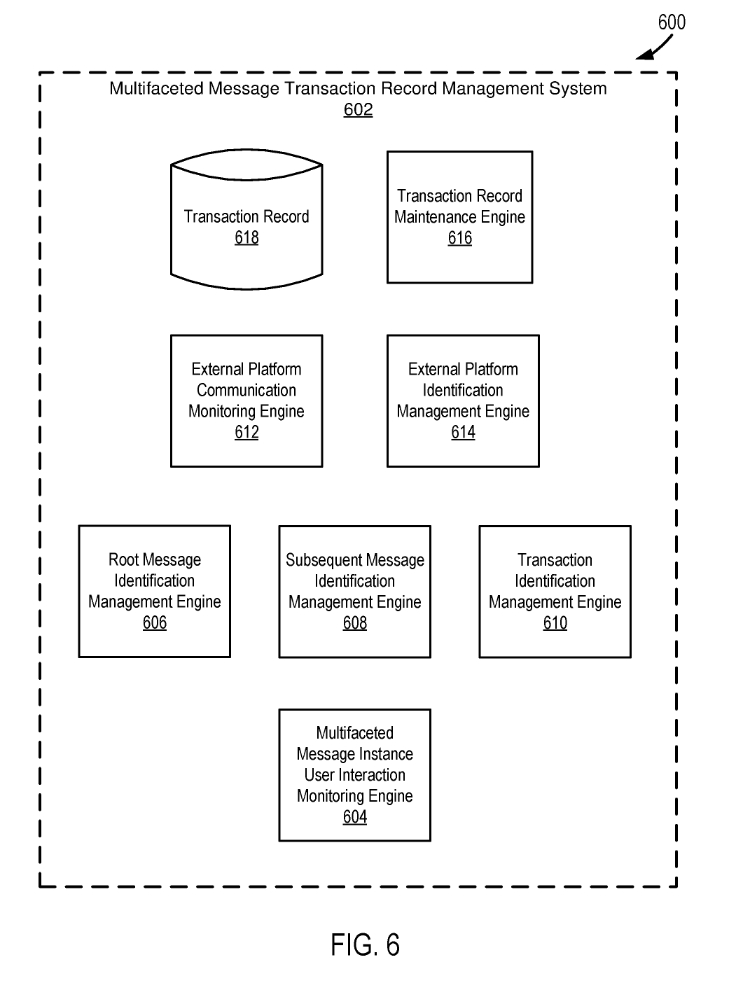

FIG. 6 depicts a diagram 600 of a multifaceted message transaction record management system 602. The multifaceted message transaction record management system 602 functions to manage a transaction record for a multifaceted message. The multifaceted message transaction record management system 602 can be included as part of an applicable platform for supporting multifaceted message communication, such as the multifaceted message platforms described in this paper. In managing a transaction record for a multifaceted message, the multifaceted message transaction record management system 602 can monitor user interactions with one or a plurality of multifaceted message instances representing the multifaceted message and maintain the transaction record according to the user interactions. Additionally, in managing a transaction record for a multifaceted message, the multifaceted message transaction record management system 602 can monitor communication regarding the multifaceted message through an external platform and maintain the transaction record according to communications made through the external platform.

The multifaceted message transaction record management system 602 includes a multifaceted message instance user interaction monitoring engine 604, a root message identification management engine 606, a subsequent message identification management engine 608, a transaction identification management engine 610, an external communication monitoring engine 612, an external platform identification management engine 614, a transaction record maintenance engine 616, and a transaction record datastore 618.

The multifaceted message instance user interaction monitoring engine 604 functions to monitor user interactions with multifaceted message instances representing multifaceted messages. In monitoring user interactions with multifaceted message instances, the multifaceted message instance user interaction monitoring engine 604 can determine when an multifaceted message instance is created. For example, the multifaceted message instance user interaction monitoring engine 604 can monitor user interactions to determine when a root multifaceted message instance or a subsequent multifaceted message instance is created. Additionally, in monitoring user interactions with multifaceted message instances, the multifaceted message instance user interaction monitoring engine 604 can determine when a user interacts with a multifaceted message instance without causing a subsequent multifaceted message instance to be created. For example, the multifaceted message instance user interaction monitoring engine 604 can determine when a user views a multifaceted message or accesses data as part of a multifaceted message without editing a multifaceted message instance through creation of a subsequent multifaceted message instance.

The root message identification management engine 606 functions to maintain root message identifications for root multifaceted message instances. In maintaining root message identifications, the root message identification management engine 606 can generate and associate a unique root message identification with a root multifaceted message instance in response to creation of the root multifaceted message instance. For example, when an applicable system for detecting creation of a root multifaceted message instance, such as the multifaceted message instance user interaction monitoring engines described in this paper, detects creation of a root multifaceted message instance, the root message identification management engine 606 can generate and associate a unique root message identification with the root multifaceted message instance. Additionally, in maintaining root message identifications, the root message identification management engine 606 can add to root message identifications one or a plurality of time stamps. For example, the root message identification management engine 606 can add time stamps to a root message identification indicating either or both when the root message identification was created and an associated root multifaceted message instance was created.

The subsequent message identification management engine 608 functions to maintain subsequent message identifications for subsequent multifaceted message instances. In maintaining subsequent message identifications, the subsequent message identification management engine 608 can generate and associate a unique subsequent message identification with a subsequent multifaceted message instance in response to creation of the subsequent multifaceted message instance. For example, when an applicable system for detecting creation of a subsequent multifaceted message instance, such as the multifaceted message instance user interaction monitoring engines described in this paper, detects creation of a subsequent multifaceted message instance, the subsequent message identification management engine 608 can generate and associate a unique subsequent message identification with the subsequent multifaceted message instance. Additionally, in maintaining subsequent message identifications, the subsequent message identification management engine 608 can add to subsequent message identifications one or a plurality of time stamps. For example, the subsequent message identification management engine 608 can add time stamps to a subsequent message identification indicating either or both when the subsequent message identification was created and an associated subsequent multifaceted message instance was created.

The transaction identification management engine 610 functions to maintain transaction identifications for user interactions with multifaceted message instances. In maintaining transaction identifications, the transaction identification management engine 610 can generate and associate a unique transaction identification with an occurrence of a user interaction with a multifaceted message instance. For example, when an applicable system for detecting creation of a subsequent multifaceted message instance, such as the multifaceted message instance user interaction monitoring engines described in this paper, detects a user has interacted with a multifaceted message instance without editing the message instance through creation of a subsequent multifaceted message instance, the transaction identification management engine 610 can generate and associate a unique transaction identification with the interaction. Additionally, in maintaining transaction identifications, the transaction identification management engine 610 can add to transaction identifications one or a plurality of time stamps. For example, the transaction identification management engine 610 can add time stamps to a transaction identification indicating either or both when the transaction identification was created and when an occurrence of user interaction with a multifaceted message instance associated with the transaction identification actually occurred.

In a specific implementation, the transaction identification management engine 610 can add data related to an occurrence of user interaction with a multifaceted message instance to a transaction identification associated with the user interaction. For example, the transaction identification management engine 610 can add data indicating a type of interaction that occurred with a multifaceted message instance to a transaction identification associated with the interaction. In another example, the transaction identification management engine 610 can add data indicating an identification of or alias associated with a user who interacted with a multifaceted message instance to a transaction identification associated with the interaction.

The external communication monitoring engine 612 functions to monitor communications with a user through an external platform regarding multifaceted message communications. In monitoring communications with a user through an external platform, the external communication monitoring engine 612 can determine whether and when a user was notified of an available multifaceted message instance to the user through an external platform. Additionally, in monitoring communications with a user through an external platform, the external communication monitoring engine 612 can determine whether and when a user was sent a multifaceted message instance interaction link.

The platform identification management engine 614 functions to maintain external platform identifications based on communications with a user through external platforms regarding multifaceted message communication. In maintaining external platform identifications, the external platform identification management engine 614 can generate and associate an external platform identification with an occurrence of a communication with a user through an external platform regarding multifaceted message communication. For example, the external platform identification management engine 614 can generate and associate a unique external platform identification to an occurrence of a user being sent a notice or a multifaceted message instance interaction link through an external platform. Additionally, in maintaining external platform identifications, the external platform identification management engine 614 can add to external platform identifications one or a plurality of time stamps. For example, the external platform identification management engine 614 can add time stamps to an external platform identification indicating either or both when the external platform identification was created and when a communication associated with the external platform identification actually occurred.

In a specific implementation, in maintaining external platform identifications, the external platform identification management engine 614 can add data related to a communication with a user through an external platform to an external platform identification. For example, the external platform identification management engine 614 can add to an external platform identification data indicating a communication type of a communication with a user through an external platform, an external platform used in providing a communication to a user, and an identification of or an alias associated with a user communicating through an external platform. For example, the external platform identification management engine 614 can add to a transaction identification an indicator that a notification of an available multifaceted message was sent to a user.

The transaction record maintenance engine 616 functions to maintain a transaction record for a multifaceted message. The transaction record maintenance engine 616 can maintain a transaction record for a multifaceted message based on one or an applicable combination of a root message identification, a subsequent message identifications, transaction identifications, and external platform identifications. For example, the transaction record maintenance engine 616 can generate a transaction record for a multifaceted message to include a root message identification associated with a root multifaceted message instance for the multifaceted message, a subsequent message identification associated with a subsequent multifaceted message instance for the multifaceted message, and transaction identifications associated with user interactions with the multifaceted message instances for the multifaceted message. Additionally, in maintaining a transaction record for a multifaceted message, the transaction record maintenance engine 616 can control user access to the transaction record based on transaction record access rights.

The transaction record datastore 618 functions to store transaction record data indicating a transaction record for a multifaceted message. The transaction record datastore 618 can store transaction record data indicating a transaction record maintained by an applicable engine for maintaining transaction records for multifaceted messages, such as the transaction record maintenance engines described in this paper. Transaction record data stored in the transaction record datastore 618 can be used to provide users with access to a transaction record for a multifaceted message.

In an example of operation of the example system shown in FIG. 6, the multifaceted message instance user interaction monitoring engine 604 monitors user interactions with multifaceted message instances representing a multifaceted message. In the example of operation of the example system shown in FIG. 6, the root message identification management engine 606 generates and associates a root message identification with a root multifaceted message instance based on the monitoring of the user interactions by the multifaceted message instance user interaction monitoring engine 604. Further, in the example of operation of the example system shown in FIG. 6, the subsequent message identification management engine 608 generates and associates a subsequent message identification with a subsequent multifaceted message instance based on the monitoring of the user interactions by the multifaceted message instance user interaction monitoring engine 604. In the example of operation of the example system shown in FIG. 6, the transaction identification management engine 610 generates and associates a transaction identifications with occurrences of user interactions with multifaceted message instances representing the multifaceted message based on the monitoring of the user interactions by the multifaceted message instance user interaction monitoring engine 604. Additionally, in the example of operation of the example system shown in FIG. 6, the transaction record maintenance engine 616 maintains a transaction record for the multifaceted message to include the root message identification, the subsequent message identification, and the transaction records.

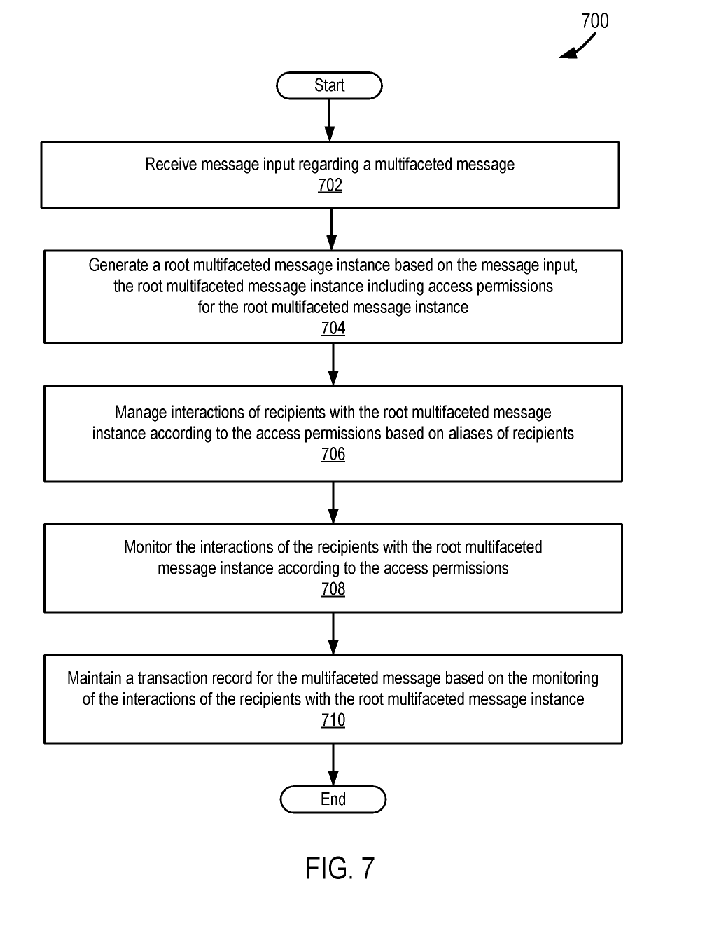

FIG. 7 depicts a flowchart 700 of an example a method for managing multifaceted message communication. The flowchart 700 begins at module 702, where message input regarding a multifaceted message is received from a generator. An applicable engine for receiving message input, such as the root message input communication engines described in this paper, can receive message input from a generator. Message input received at module 702 includes access permissions used in controlling user interaction with a root multifaceted message instance generated based on the message input. Additionally, message input received at module 702 can include either or both content to display and data to attach to a multifaceted message for use in providing users interaction with the multifaceted message according to access permissions.

The flowchart 700 continues to module 704, where a root multifaceted message instance is generated based on the message input. A root multifaceted message instance generated at module 704 based on message input includes access permissions for the root multifaceted message instance, as defined according to the message input. A root multifaceted message instance can be generated based on the message input by an applicable engine for managing root multifaceted message instances, such as the root multifaceted message instance maintenance engines described in this paper.

The flowchart 700 continues to module 706, where interactions of recipients with the root multifaceted message instance are managed according to the access permissions based on aliases of the recipients. An applicable engine for managing user interactions with multifaceted message instances, such as the multifaceted message instance interaction control engines described in this paper, can manage interactions of recipients with the root multifaceted message instance according to the access permissions based on aliases of the recipients. In managing recipient interactions with the root multifaceted message instance, content of a multifaceted message can be presented to recipients according to the access permissions defined for the recipients. Additionally, in managing recipient interactions with the root multifaceted message instance, message input can be generated indicating edits to make to the root multifaceted message instance through creation of a subsequent multifaceted message instance.

The flowchart 700 continues to module 708, where the interactions of the recipients with the root multifaceted message instance according to the access permissions are monitored. An applicable engine for monitoring user interaction with a multifaceted message instance, such as the multifaceted message instance user interaction monitoring engines described in this paper, can monitor interactions of the recipients with the root multifaceted message instance. In monitoring interactions of the recipients with the root multifaceted message instance, it can be determined whether the recipients interacted with the root multifaceted message instance without providing or generating message input indicating desired changes of the recipients to the root multifaceted message instance.

The flowchart 700 continues to module 710, where a transaction record is maintained for the multifaceted message based on the monitoring of the interactions of the recipients with the root multifaceted message instance. An applicable engine for maintaining a transaction record for a multifaceted message, such as the transaction record maintenance engines described in this paper, can maintain a transaction record for the multifaceted message based on the monitoring of the interactions of the recipients with the root multifaceted message instance. A transaction record can be maintained based on one or an applicable combination of root message identifications, subsequent message identifications, transaction identifications, and external platform identifications generates for a multifaceted message, potentially generated based on the recipient interactions with the root multifaceted message instance.

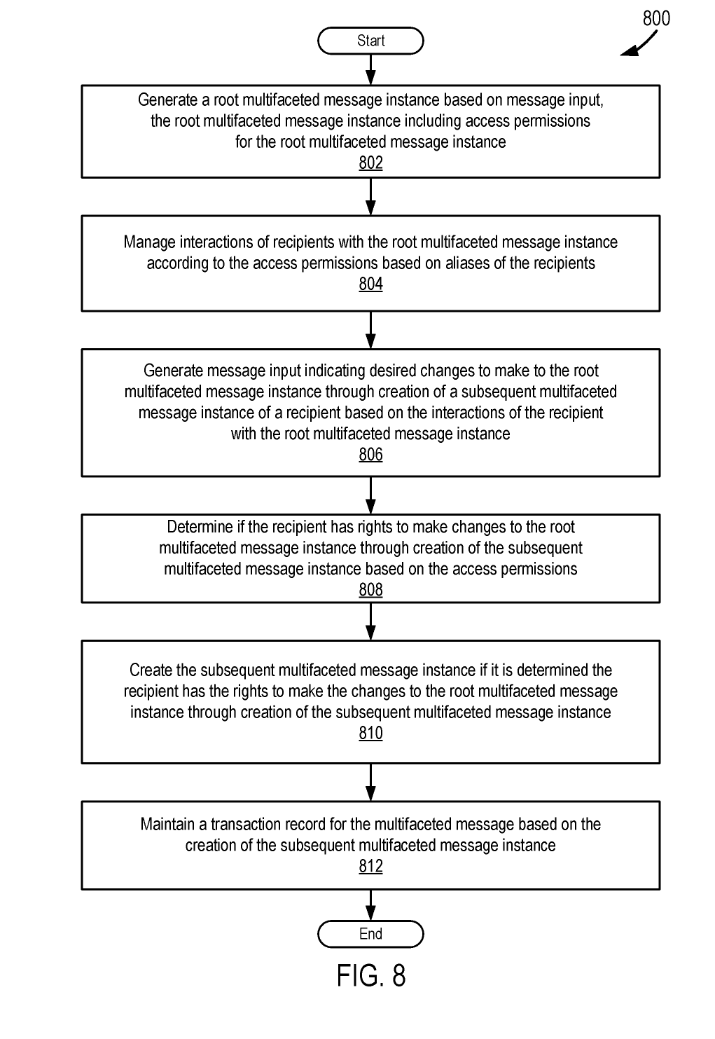

FIG. 8 depicts a flowchart 800 of an example of a method for maintaining a subsequent multifaceted message instance. The flowchart 800 begins at module 802, where a root multifaceted message instance is generated based on message input. A root multifaceted message instance generated at module 802 based on message input includes access permissions for the root multifaceted message instance, as defined according to the message input. A root multifaceted message instance can be generated based on message input by an applicable engine for managing root multifaceted message instances, such as the root multifaceted message instance maintenance engines described in this paper.

The flowchart 800 continues to module 804, where interactions of recipients with the root multifaceted message instance are managed according to the access permissions based on aliases of the recipients. An applicable engine for managing user interactions with multifaceted message instances, such as the multifaceted message instance interaction control engines described in this paper, can manage interactions of recipients with the root multifaceted message instance according to the access permissions based on aliases of the recipients. In managing recipient interactions with the root multifaceted message instance, content of a multifaceted message can be presented to recipients according to the access permissions defined for the recipients.

The flowchart 800 continues to module 806, where message input is generated indicating desired changes a recipient of the recipients wishes to make to the root multifaceted message instance through creation of a subsequent multifaceted message instance. Message input indicating desired changes of a recipient of the recipients to make to the root multifaceted message instance through creation of a subsequent multifaceted message instance are generated according to interactions of the recipient with the root multifaceted message instance. For example, a recipient can specify in interacting with the root multifaceted message instance a desire to change content presented as part of a multifaceted message represented by the root multifaceted message instance and based on the interactions of the recipient, message input indicating the desire to change the content can be generated. An applicable engine for managing multifaceted message instance interaction, such as the multifaceted message instance interaction control engines described in this paper, can generate message input indicating desired changes of a recipient of the recipients wishes to make to the root multifaceted message instance through creation of a subsequent multifaceted message instance.

The flowchart 800 continues to module 808, where it is determined if the recipient has rights to make changes to the root multifaceted message instance through creation of the subsequent multifaceted message instance based on the access permissions. An applicable engine for managing subsequent multifaceted message instance creation, such as the subsequent multifaceted message instance maintenance engines described in this paper, can determine if the recipient has rights to make changes to the root multifaceted message instance through creation of the subsequent multifaceted message instance based on the access permissions. Whether the recipient has rights to make changes to the root multifaceted message instance through creation of the subsequent multifaceted message instance can depend on the types of desired changes the recipient wishes to make. For example, if the recipient wants to change the access permissions of the root multifaceted message and the access permissions specify the recipients are not allowed to change the access permissions, then it can be determined the recipient does not have the right to make the desired changes to the root multifaceted message instance.

The flowchart 800 continues to module 810, where the subsequent multifaceted message instance is created, if it is determined that the recipient has the rights to make the changes to the root multifaceted message instance through creation of the subsequent multifaceted message instance. An applicable engine for managing subsequent multifaceted message instance creation, such as the subsequent multifaceted message instance maintenance engines described in this paper, can create the subsequent multifaceted message instance is created, if it is determined that the recipient has the rights to make the changes to the root multifaceted message instance through creation of the subsequent multifaceted message instance. In creating the subsequent multifaceted message instance, multifaceted message instance data can be updated or generated to indicate the subsequent multifaceted message instance.

The flowchart 800 continues to module 812, where a transaction record for the multifaceted message is maintained based on the creation of the subsequent multifaceted message instance. An applicable engine for maintaining transaction records for multifaceted messages, such as the transaction record maintenance engines described in this paper, can maintain a transaction record to the multifaceted message based on the creation of the subsequent multifaceted message instance. In maintaining a transaction record for the multifaceted message based on the creation of the subsequent multifaceted message instance, the transaction record can be updated to include a unique subsequent message identification associated with the subsequent multifaceted message instance.

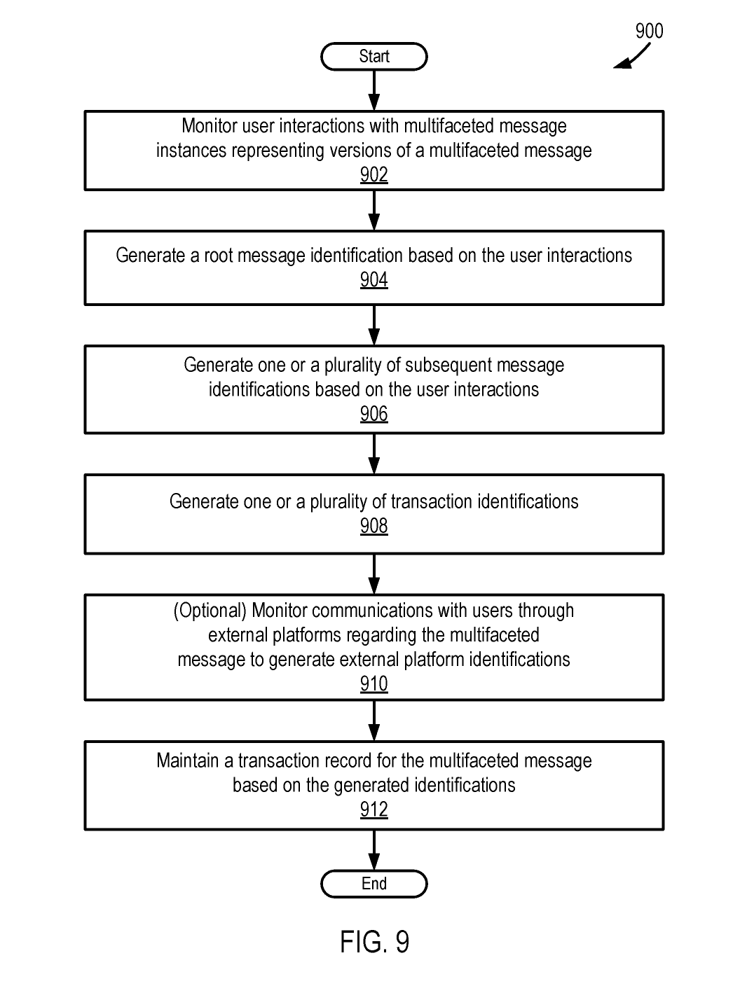

FIG. 9 depicts a flowchart 900 of an example of a method for maintaining a transaction record for a multifaceted message. The flowchart 900 begins at module 902, where user interactions with multifaceted message instances representing versions of a multifaceted message are monitored. An applicable engine for monitoring user interactions with multifaceted message instances, such as the multifaceted message instance user interaction monitoring engines described in this paper, can monitor user interactions with multifaceted message instances representing versions of a multifaceted message. In monitoring user interactions with multifaceted message instances it can be determined when an multifaceted message instance is created. For example, user interactions can be monitored to determine when a subsequent multifaceted message instance or a root multifaceted message instance is created. Additionally, in monitoring user interactions with multifaceted message instances it can be determined when a user interacts with a multifaceted message instance without causing a subsequent multifaceted message instance to be created.

The flowchart 900 continues to module 904, where a root message identification is generated based on the user interactions. An applicable engine for maintaining root message identifications, such as the root message identification management engines described in this paper, can generate a root message identification based on the user interactions. Specifically, a root message identification can be generated when a root multifaceted message instance is created. A generated root message identification can be uniquely associated with a root multifaceted message instance for which the root message identification is created.

The flowchart 900 continues to module 906, where one or a plurality of subsequent message identifications are generated based on the user interactions. An applicable engine for maintaining subsequent message identifications, such as the subsequent message identification management engines described in this paper, can generate one or a plurality of subsequent message identifications based on the user interactions. Specifically, a subsequent message identification can be generated when a subsequent multifaceted message instance is created. A subsequent message identification can be uniquely associated with a subsequent multifaceted message instance for which the subsequent message identification is created.

The flowchart 900 continues to module 908, where one or a plurality of transaction identifications are generated based on the user interactions. An applicable engine for maintaining transaction identifications, such as the transaction identification management engines described in this paper, can generate one or a plurality of transaction identifications based on the user interactions. Specifically, a transaction identification can be generated when a user interacts with a multifaceted message instance without causing creation of a subsequent multifaceted message instance. A transaction identification can be uniquely associated with user interaction occurrence for which the transaction identification is created.

The flowchart 900 continues to module 910, where, optionally, communications with users through external platforms regarding the multifaceted message is monitored to generate external platform identifications. An applicable engine for monitoring communication with users through external platforms regarding multifaceted message communication, such as the external platform communication monitoring engines described in this paper, can monitor communications with users through external platforms regarding the multifaceted message. For example, it can be determined when a notification is sent to a recipient regarding a multifaceted message through an external platform and in response an external platform identification can be created and associated with the occurrence of sending of the notification.

The flowchart 900 continues to module 912, where a transaction record for the multifaceted message is maintained based on the generated identifications. An applicable engine for maintaining a transaction record for a multifaceted message, such as the transaction record maintenance engines described in this paper, can maintain a transaction record for the multifaceted message based on the generated identifications. A transaction record for the multifaceted message can be maintained based on one or an applicable combination of the root message identification, the one or a plurality of subsequent message identifications, the one or a plurality of transaction identifications, and the external platform identifications.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving message input from an originator regarding a multifaceted message;
generating a root multifaceted message instance based on the message input, the root multifaceted message instance including access permissions for recipients in interacting with the root multifaceted message instance and aliases of the recipients;
managing interactions of the recipients with the root multifaceted message instance according to the access permissions based on the aliases of the recipients;
monitoring the interactions of the recipients with the root multifaceted message instance according to the access permissions;
maintaining a transaction record for the multifaceted message based on the monitoring of the interactions of the recipients with the root multifaceted message instance.

2. The method of claim 1, wherein the aliases of the recipients are publicly searchable.

3. The method of claim 1, wherein the root multifaceted message instance includes first content and second content and the access permissions specify displaying the first content to a first recipient of the recipients as part of the first recipient interacting with the root multifaceted message instance and displaying the second content to a second recipient of the recipients as part of the second recipient interacting with the root multifaceted message instance, the method further comprising:
presenting the first content to the first recipient as part of managing interactions of the recipients with the root multifaceted message instance according to the access permissions based on the aliases of the recipients;
presenting the second content to the first recipient as part of managing interactions of the recipients with the root multifaceted message instance according to the access permission based on the aliases of the recipients.

4. The method of claim 1, further comprising:
generating additional message input based on specific interactions of a recipient of the recipients with the root multifaceted message instance, the additional message input indicating desired changes of the recipient to the root multifaceted message instance;
determining, according to the access permissions, if the recipient has rights to edit the root multifaceted message instance through generation of a subsequent multifaceted message instance;
if it is determined that the recipient has rights to edit the root multifaceted message instance through generation of the subsequent multifaceted message instance, generating the subsequent multifaceted message instance to include the desired changes of the recipient to the root multifaceted message instance.

5. The method of claim 1, further comprising:
generating additional message input based on specific interactions of a recipient of the recipients with the root multifaceted message instance, the additional message input indicating desired changes of the recipient to the root multifaceted message instance;
determining, according to the access permissions, if the recipient has rights to edit the root multifaceted message instance through generation of a subsequent multifaceted message instance;
if it is determined that the recipient has rights to edit the root multifaceted message instance through generation of the subsequent multifaceted message instance, generating the subsequent multifaceted message instance to include the desired changes of the recipient to the root multifaceted message instance;
generating a unique subsequent message identification based on the generating of the subsequent multifaceted message instance;
associating the unique subsequent message identification with the subsequent multifaceted message instance;
updating the transaction record to include the unique subsequent message identification.

6. The method of claim 1, wherein the access permissions specify whether a recipient of the recipients can modify the access permissions in editing the root multifaceted message instance by generating a subsequent multifaceted message instance.

7. The method of claim 1, further comprising:
generating a unique root message identification based on the generating of the root multifaceted message instance;
associating the unique root message identification with the root multifaceted message instance;
updating the transaction record to include the root message identification.

8. The method of claim 1, further comprising:
generating additional message input based on specific interactions of a recipient of the recipients with the root multifaceted message instance, the additional message input indicating desired changes of the recipient to the access permissions of the root multifaceted message;
determining, according to the access permissions, if the recipient has rights to edit the access permissions of the root multifaceted message instance through generation of a subsequent multifaceted message instance;
if it is determined that the recipient has rights to edit the access permissions of the root multifaceted message instance through generation of the subsequent multifaceted message instance, generating the subsequent multifaceted message instance to include the desired changes of the recipient to the access permission of the root multifaceted message instance.

9. The method of claim 1, further comprising sending a multifaceted message instance interaction link to a recipient of the recipients through an external platform, the multifaceted message interaction link used by the recipient to access the root multifaceted message instance for purposes of interacting with the root multifaceted message instance.

10. The method of claim 1, wherein, the subsequent multifaceted message instance include a link to the root multifaceted message instance and used by a recipient to access the root multifaceted message instance for purposes of interacting with the root multifaceted message instance.

11. A system comprising:
a root message input communication engine configured to receive message input from an originator regarding a multifaceted message;
a root message multifaceted message instance maintenance engine configured to generate a root multifaceted message instance based on the message input, the root multifaceted message instance including access permissions for recipients in interacting with the root multifaceted message instance and aliases of the recipients;
a multifaceted message instance interaction control engine configured to manage interactions of the recipients with the root multifaceted message instance according to the access permissions based on the aliases of the recipients;
a multifaceted message instance user interaction monitoring engine configured to monitor the interactions of the recipients with the root multifaceted message instance according to the access permissions;
a transaction record maintenance engine configured to maintain a transaction record for the multifaceted message based on the monitoring of the interactions of the recipients with the root multifaceted message instance.

12. The system of claim 11, wherein the aliases of the recipients are publicly searchable.

13. The system of claim 11, wherein the root multifaceted message instance includes first content and second content and the access permissions specify displaying the first content to a first recipient of the recipients as part of the first recipient interacting with the root multifaceted message instance and displaying the second content to a second recipient of the recipients as part of the second recipient interacting with the root multifaceted message instance, the multifaceted message instance interaction control engine further configured to:
present the first content to the first recipient as part of managing interactions of the recipients with the root multifaceted message instance according to the access permissions based on the aliases of the recipients;
present the second content to the first recipient as part of managing interactions of the recipients with the root multifaceted message instance according to the access permission based on the aliases of the recipients.

14. The system of claim 11, wherein the multifaceted message instance interaction control engine is further configured to generate additional message input based on specific interactions of a recipient of the recipients with the root multifaceted message instance, the additional message input indicating desired changes of the recipient to the root multifaceted message instance, the system further comprising a subsequent multifaceted message instance maintenance engine configured to:
determine, according to the access permissions, if the recipient has rights to edit the root multifaceted message instance through generation of a subsequent multifaceted message instance;
generate the subsequent multifaceted message instance to include the desired changes of the recipient to the root multifaceted message instance, if it is determined that the recipient has rights to edit the root multifaceted message instance through generation of the subsequent multifaceted message instance.

15. The system of claim 11, wherein the multifaceted message instance interaction control engine is further configured to generate additional message input based on specific interactions of a recipient of the recipients with the root multifaceted message instance, the additional message input indicating desired changes of the recipient to the root multifaceted message instance, the system further comprising:
a subsequent multifaceted message instance maintenance engine configured to:
determine, according to the access permissions, if the recipient has rights to edit the root multifaceted message instance through generation of a subsequent multifaceted message instance;
generate the subsequent multifaceted message instance to include the desired changes of the recipient to the root multifaceted message instance, if it is determined that the recipient has rights to edit the root multifaceted message instance through generation of the subsequent multifaceted message instance;
a subsequent message identification management engine configured to:
generate a unique subsequent message identification based on the generating of the subsequent multifaceted message instance;
associate the unique subsequent message identification with the subsequent multifaceted message instance;
the transaction record maintenance engine further configured to update the transaction record to include the unique subsequent message identification.

16. The system of claim 11, wherein the access permissions specify whether a recipient of the recipients can modify the access permissions in editing the root multifaceted message instance by generating a subsequent multifaceted message instance.

17. The system of claim 11, further comprising:
a root message identification management engine configured to:
generate a unique root message identification based on the generating of the root multifaceted message instance;
associate the unique root message identification with the root multifaceted message instance;
the transaction record maintenance engine further configured to update the transaction record to include the root message identification.

18. The system of claim 11, wherein the multifaceted message instance interaction control engine is further configured to generate additional message input based on specific interactions of a recipient of the recipients with the root multifaceted message instance, the additional message input indicating desired changes of the recipient to the access permissions of the root multifaceted message, the system further comprising:
a subsequent multifaceted message instance maintenance engine configured to:
determine, according to the access permissions, if the recipient has rights to edit the access permissions of the root multifaceted message instance through generation of a subsequent multifaceted message instance;
generate the subsequent multifaceted message instance to include the desired changes of the recipient to the access permission of the root multifaceted message instance, if it is determined that the recipient has rights to edit the access permissions of the root multifaceted message instance through generation of the subsequent multifaceted message instance.

19. The system of claim 11, further comprising an external platform communication engine configured to send a multifaceted message instance interaction link to a recipient of the recipients through an external platform, the multifaceted message interaction link used by the recipient to access the root multifaceted message instance for purposes of interacting with the root multifaceted message instance.

20. A system comprising:
means for receiving message input from an originator regarding a multifaceted message;
means for generating a root multifaceted message instance based on the message input, the root multifaceted message instance including access permissions for recipients in interacting with the root multifaceted message instance and aliases of the recipients;
means for managing interactions of the recipients with the root multifaceted message instance according to the access permissions based on the aliases of the recipients;
means for monitoring the interactions of the recipients with the root multifaceted message instance according to the access permissions;
means for maintaining a transaction record for the multifaceted message based on the monitoring of the interactions of the recipients with the root multifaceted message instance.
